(19) United States
(12) Patent Application Publication
(10) Pub. No.: US 2026/0257758 A1
(43) Pub. Date: Sep. 3, 2026

(54) DRIVE ARRANGEMENT FOR AN E-BIKE

(71) Applicant: MYSTROMER AG, Oberwangen (CH)

(72) Inventors: Markus WITTWER, Heimenschwand (CH); Karl Ludwig KLEY, Frankfurt am Main (DE)

(73) Assignee: MYSTROMER AG, Oberwangen (CH)

(21) Appl. No.: 19/156,216

(22) PCT Filed: Feb. 12, 2024
(86) PCT No.: PCT/IB2024/051284

§ 371 Date: Aug. 13, 2025

(30) Foreign Application Priority Data
Feb. 13, 2023 (CH) CH000125/2023

(51) Int. Cl. B62M 6/50; B62J 45/411; B62J 45/42; B62M 6/60

(52) U.S. Cl. CPC B62M 6/50; B62J 45/411; B62J 45/42; B62M 6/60

(57) ABSTRACT

The present invention relates to an electric drive arrangement, in particular for an e-bike. An inner part of the electric drive comprises a sensor, and a measurement element which can be coupled to a freewheel. The measurement element is arranged in the region of an axle of a running wheel and the sensor performs a function which measures drive support. Furthermore, the inner part of the electric drive is protected against external unwanted influences by a housing consisting of two cover bodies. This housing is screwed to a running wheel of the e-bike by means of a support element. The radial movement of the axle is ensured by two bearings. The electric drive is connected, as a complete component, to the pedals of the e-bike via a belt or chain by way of a freewheel.

The present invention relates to an electric drive comprising a sensor according to the preamble of claim 1.

### TECHNICAL BACKGROUND

Two basic starting points for the electric drive are known from the prior art. It can be mounted in the form of a hub-mounted motor in the front or rear wheel or in the form of a mid-mounted motor on the chain in the middle of a bicycle. Furthermore, the drives are divided into direct drives and geared motors. The difference between these two categories is mainly that geared motors, in contrast to direct drives, have a transmission and usually do not have a freewheel.

Electric bicycles are generally equipped with either a torque sensor or a cadence sensor, which determines the assistance provided to the rider while they are pedaling. While cadence sensors measure whether a rider is pedaling, torque sensors measure how hard the rider is pedaling. The basic difference in the drive control is that, in a cadence sensor, the drive assistance decreases as the rider's pedaling speed increases. In electric bicycles which are equipped with a torque sensor, the behavior is the reverse, i.e. the harder the rider pedals, the more torque and thus power the electric drive provides. This means that riding in which the assistance is determined by the torque sensor provides a more natural and intuitive riding experience than if the cadence sensor is used.

In the prior art, there are documents that deal with torque measurement in electric drives by means of a torque transducer.

EP3029442A1 discloses a freewheel hub which is used for measuring the torque exerted on a bicycle wheel. It comprises a rotating hub housing, which is fastened to the wheel, and a torque-transmitting element (e.g. a shaft), which is connected to the hub housing. The element has one or more magnetoelastically active regions, which change their magnetic polarization as a response to the applied torque. A magnetoelastic sensor that is equipped with magnetic-field sensors and is fastened to a non-rotating axle detects the changes in the magnetic flow in these active regions in order to determine the torque. The hub can contain functions such as freewheel coupling or a freewheel, wherein the sensors are attached in a hollow shaft for improved accuracy of the torque measurement. It is capable of compensating for external magnetic interferences and consists of materials that improve its magnetoelastic properties. Nevertheless, this technical solution has certain drawbacks, such as greater complexity of the system. Incorporating a plurality of magnetoelastic active regions, sensors, and the associated electronics can make the construction and maintenance of the system more complex and expensive. Furthermore, the freewheel is not coupled to the torque sensor directly or exclusively in an intermediary manner, which means that the torque is only measured indirectly. This indirect measurement could lead to lags or inaccuracies.

DE102021126910A1 describes a bicycle motor comprising a wheel axle, a hub housing, and a housing cover, which contains a plurality of through-holes for the wheel axle and fastening elements. A driver receives the torque and relays it, via pins, to a measuring disk, which is located in the interior of the motor. This disk transmits the torque to the hub housing and its deformation is detected by a torque-measuring apparatus in order to determine the applied torque. A drawback of this solution is the two-part design of the wheel axle, which is a potential weak point in the mechanical structure, since the wheel axle is subjected to higher forces at each of the ends, which results in an increased risk of wheel-axle alignment.

According to the prior art, a torque sensor connected to the electric drive positioned on the axle is mounted on the axle beside it. This entails several drawbacks. A torque sensor located outside the electric drive is more susceptible to damage. Furthermore, the measured signal is more dynamic, since other influences determine the signal, which places higher demands on the evaluation. Not least, the positioning of the torque sensor on the axle is not a compact solution, and this can make it more difficult to replace a brake disk, for example.

### DESCRIPTION OF THE INVENTION

One problem addressed by the invention is to avoid at least one of the drawbacks of the prior art. In particular, one problem addressed by the invention is that of reliably measuring the torque by means of a sensor and thus of allowing the e-bike to be ridden safely and comfortably.

Another problem addressed by the invention is that of providing a complex electric drive solution, wherein the electric drive is designed together with a sensor as a complete component of the electric bicycle.

These problems are solved by the features of independent claim 1.

This solution allows the sensor to be better protected against external influences and also provides a more compact appearance of the bicycle, which makes it easier to mount or dismount the components attached around an axle.

In particular, the problem addressed by the invention is solved by an electric drive arrangement according to the invention.

The solution according to the invention comprises an electric drive, in particular for an e-bike, which comprises a housing having two cover bodies. An axle guided through the two cover bodies and at least one bearing and a carrier comprising a bearing seat are likewise part of the construction. Furthermore, the disclosure contains a sensor, which is arranged in the region of the axle of a wheel to measure the drive assistance, and a measurement element, which can be coupled to a freewheel by means of a connection pattern. In this case, a force being transmitted can be detected at the measurement element by the sensor. In addition, the at least one bearing can be fitted to an outer surface of the bearing seat.

The technical solution described for an electric drive, specifically for an e-bike, provides several advantages, which can improve both the power and the reliability and ease of maintenance of the system.

The construction comprising two cover bodies simplifies the mounting and dismounting of the electric drive. This is particularly advantageous for maintenance work or for replacing components, since the housing can be easily opened in order to gain access to internal parts such as the axle, bearings, and the carrier.

In addition, incorporating a torque sensor which measures the force acting on the measurement element makes it possible to accurately determine the required assistance from the electric drive which is to be provided to the e-bike.

The manner in which the bearing is fitted to the outer surface of the bearing seat is likewise a significant advantage. Conventional constructions tend to place the bearing around the axle, and while this is functional, it can result in uneven loading and increased wear. By the bearing instead being fitted to the bearing seat, more even force distribution is obtained. In order to further improve the force distribution, a second bearing can advantageously be integrated in the construction of the electric drive.

Lastly, the connection pattern is advantageously a set of teeth. The set of teeth allows for high precision when transmitting force, since the meshing teeth ensure a stable and non-slip connection. Furthermore, the set of teeth provides improved durability and an improved service life of the connection, since the load is distributed more evenly over the contact surfaces, which minimizes the wear.

Nevertheless, other connection techniques, for example a thread or magnetic couplings, can also be used. Magnetic couplings provide the advantage of contactless force transmission, which reduces the mechanical wear and can extend the service lives of the components.

The solution according to the invention can be supplemented with and further improved as desired by the following further configurations, which are each advantageous per se.

According to one embodiment, it is provided that the sensor is positioned together with the measurement element in a housing of the electric drive.

By positioning the sensor together with the measurement element in the housing of the electric drive, a higher level of integration is obtained. This approach protects the critical sensor elements against external influences such as dust, water, and mechanical loading, which improves the reliability and service life of the sensor. Furthermore, the internal arrangement contributes to maintaining the functionality under rough operating conditions and ensures consistent power over the entire service life of the electric drive.

The proximity of the sensor to the measurement element within the protected housing also minimizes potential interferences and signal losses, which can occur for longer transmission paths. This ensures high signal integrity and allows the measured data to be detected in a more precise and reliable manner, and this is of importance for fine-tuning the drive assistance and improving the total power of the electric drive.

According to a preferred embodiment, it is provided that the measurement element is integrated in the motor and has the shape of a sleeve.

The sleeve-shaped design of the measurement element allows it to be easily mounted around the axle of the wheel. This design ensures simplified installation and allows for seamless integration with other components of the drive system, for example by using a thread mechanism for a precise and secure coupling. This significantly increases the efficiency of the mounting processes, which involves a reduction in the production times and costs.

Furthermore, the measurement element is advantageously made of an exceptionally strong material, which promotes the accuracy and repeatability of the measurements. The use of high-strength materials minimizes the deformation under load, which ensures consistent measurement accuracy over the service life of the product.

Lastly, the sleeve-shaped construction is designed such that it is resistant to external interference factors such as vibrations, temperature fluctuations, and other physical influences. This resilience ensures that such influences do not impair the measurement accuracy, which improves the reliability and stability of the sensor data under varying operating conditions.

According to another embodiment, it is provided that the measurement element is magnetized.

The magnetization of the measurement element allows for a measurement in a contactless manner. This amounts to significant progress, since the wear susceptibility is drastically reduced by eliminating mechanical contact points. The service life of the measurement element and the reliability of the measurement are considerably improved thereby. Furthermore, this configuration minimizes the necessity for direct physical interactions between the measurement element and other components of the drive system, which reduces the potential interferences and error sources during the measurement.

Another advantage of the magnetization is that measurements are possible from a greater distance. This allows the measurement element to be positioned flexibly relative to the sensor-based detection units, which increases the freedom of design and makes it possible to adapt to different constructions and requirements of the electric drive system.

Lastly, the selection of a suitable material for the magnetized measurement element is essential. It is advantageous to use an NdFeB alloy (neodymium, iron, and boron) owing to its strong magnetic properties and the high energy density. This material allows a stable magnetic field to be generated for precise, contactless measurements. NdFeB also provides good corrosion resistance and temperature resistance, which ensures the reliability of the measurement element under various operating conditions.

According to another embodiment, it is provided that the two cover bodies are coupled to spokes of the wheel by a spoke connection.

The construction of the spoke connection is therefore advantageous because the spokes of the wheel can be easily connected to the housing. They remain straight and do not require any bending in the spoke connection. Therefore, it can be maintained that this solution also simplifies their production. In addition, the housing thus becomes more stable, since the spoke connection acts as an additional support structure. Another advantage is that the housing has a standardized shape which is simple to maintain and repair.

According to another embodiment, it is provided that the housing can be coupled to the wheel by a support element.

The support element is rigidly connected to the housing and the wheel, for example by screws. This ensures that the entire electric drive is well anchored in the wheel and cannot move. Furthermore, both the support element and the entire housing can be made of plastics material or metal, for example. Not least, it is also advantageous for the housing to be attached directly to the wheel of the e-bike by one of the cover bodies and the support element.

According to another embodiment, it is provided that the support element has a sleeve shape.

This design allows it to be connected to the housing in a simple manner. This can be carried out by screws, for example. In addition, the support element can comprise a range of further features, such as a handle, a groove, a clip, or a similar component, in order to simplify the handling of the housing. In addition, the support element can be made of a suitable material, such as metal or plastics material.

Furthermore, it is particularly advantageous for a radial movement of the axle relative to the radially fixed housing to be made possible by a first bearing A and a second bearing B. The bearings A and B ensure that a force acting on the axle is transmitted from the axle to the electric drive, since they hold the electric drive in position while the axle and thus the wheel rotate. It is advantageous to place the bearings A and B around the axle and to position the cover bodies on its outer side. Furthermore, it is possible to use different types of bearing, such as ball bearings, roller bearings, or cylinder bearings. Not least, regular inspection and lubrication are recommended in order to ensure that they function properly.

According to another embodiment, it is provided that the sensor is provided on the carrier.

This ensures that the sensor cannot move freely along the axle. Without it being fixed, this could lead to inaccuracies in the measurement and thus to the electric drive assistance being incorrectly determined. Furthermore, even if just one screw is required to fix it, it is recommended that at least two are used, in order to obtain a more robust construction solution.

According to another embodiment, it is provided that a force originating from pedaling can be transmitted to the measurement element via the freewheel, which is also called an overrunning clutch.

When a rider pedals, the force generated by this movement is transmitted to the freewheel by a belt or a chain, for example. The freewheel function and the connection between the belt/chain and the axle can be decoupled. This has the advantage that the pedals do not continue to turn when the bicycle is being ridden without the rider pedaling.

According to another embodiment, it is provided that a force being transmitted can be measured at the measurement element.

As already mentioned, the measurement element is located in the housing of the electric drive. This is advantageous not only for protecting against external influences, but also for signal measurement. Since the force can be measured inside the housing, the signal corresponding to the force to be measured is not as dynamic as in a measurement outside the housing. This means that the electric drive assistance can be determined in a simpler, improved manner.

According to another embodiment, it is provided that the force being transmitted can be detected by the sensor in the form of a magnetic field strength.

The change in the magnetic field strength corresponds to the force with which a rider is pedaling. This determines how much assistance the electric drive should provide to the rider while they are pedaling. It is also advantageous for the axle to be directly magnetized and for the magnetic field strength to be able to be measured directly on the axle. This allows the force from pedaling to be detected rapidly and accurately without an additional measurement element being required.

According to another embodiment, it is provided that the sensor is designed as a force sensor and advantageously as a torque sensor.

In the solution presented here, a sensor is used which measures the strength of the magnetic field, which is converted into a torque. On the basis of this measurement and conversion, the level of electric drive assistance is then determined. The measurement accuracy can be further improved by using special sensors, such as angular sensors or speed sensors. The use of special software algorithms can further improve the accuracy and precision.

According to another embodiment, it is provided that the sensor can be calibrated.

During sensor calibration, the sensor output is set such that it matches the actual value of the parameter to be measured. A calibration of this kind is a prerequisite for the sensor to always function correctly and without errors and thus for a safe and comfortable ride. Furthermore, a calibration is recommended at least every six months, but preferably every three months. It is advantageous for the calibration to be automated, specifically using software which makes it possible to carry this out continuously or regularly.

According to another embodiment, it is provided that the coupling between the freewheel and the measurement element takes place directly or exclusively in an intermediary manner.

This solution entails significant advantages. Couplings of this kind ensure that force is transmitted from the wheel to the measurement element in an exact manner, which can increase the accuracy of the sensor system. In the context of an e-bike, this allows the drive assistance to be measured more accurately, which potentially leads to optimized control of the electric drive. As a result, the energy consumption can be reduced and the range of the electric bicycle can be increased.

Other embodiments are also possible. For instance, the sensor can consist of two measuring disks, a torsion bar, and a measuring sleeve. The torsion bar is held on the carrier by at least one cylindrical pin and the sensor is positioned in the housing of the electric drive as a complete component. The measuring sleeve is coupled to a belt or a chain of a bicycle via the freewheel. Furthermore, both the measuring sleeve and the at least two measuring disks are magnetized. The intensity of the magnetic field measured between the at least two magnetized measuring disks can be evaluated by a Hall sensor. Furthermore, the measuring sleeve has a thread, which relays the force being transmitted to and measured by the measuring sleeve to the electric drive. This force corresponds to the intensity with which a rider is pedaling.

Within the electric drive, it is also possible to measure not only the torque but also the travel speed of a bicycle, specifically by means of Hall sensors. The Hall sensors can be attached in the stator between the coils. Furthermore, they can also ascertain the travel direction in addition to the travel speed. The sensors detect the position of the rotor and measure the speed and the direction. This information can then be transmitted to the electronic controller, which then releases or transmits the required current to the motor.

The maximum level of electrical assistance can be adapted in the following three steps, for example. First, a controller of the e-bike should be checked and replaced if necessary. This controller is the brain of the entire e-bike and interconnects all the electronically controlled parts by supplying these parts with energy. It also determines the maximum current intensity which can be transmitted from a battery to the electric drive. By replacing the controller, the maximum current value can potentially be changed. The second aspect which determines the maximum level of electrical assistance is the battery. More specifically, this is the capacity of a battery management system, since this system determines what maximum current the battery can provide. Even if the battery is replaced with another battery having a greater capacity, the level of electrical assistance does not automatically increase as a result, since the maximum current which the battery management system permits potentially remains the same or even is lower. The last step for increasing the power and thus the maximum provided electrical assistance is that of ensuring that the electrical wiring of the electric drive is configured for the increased current. If this is not the case, it will be necessary to upgrade the wiring.

So that a rider does not need to think about regular calibration, it is particularly advantageous to automatically provide a warning for this by means of a message on a display when the e-bike is switched on. The rider can be made aware of the need for a calibration via a smartphone app connected to the controller of the e-bike. The use of an application with an Internet connection could also allow calibration data to be exchanged, which would provide valuable data for optimizing the ride experience. In order to further improve the safety, the next ride of the e-bike can be made dependent on carrying out the calibration of the sensor. This means that the electric drive can only be reactivated after a regular calibration. It is also possible to automate the calibration process of the sensor by automatically calibrating the sensor every time the electric drive is activated. However, the calibration does take some time. During this calibration phase, the current supply is de-activated in order to ensure the safety of the rider and to allow for error-free calibration of the sensor. Furthermore, it is important for a rider not to pedal during the calibration phase.

The accuracy of the level of electrical assistance depends not only on the accuracy of the torque measurement by the sensor, but also on the state of the electric drive. In this sense, “state” for example means its temperature or the aging of the materials used, for example for the stator windings. These parameters change over time or in the activated and deactivated modes. Generally, however, the state of the electric drive and/or its deviation from the optimal operating point is not taken into account, and optimal parameters such as new goods or room temperature are taken as a starting point. This does not correspond to reality, however, and the power output by the electric motor fluctuates precisely owing to these parameters. Therefore, it is possible to use a system which determines the actual operating point of the electric drive on the basis of the input current and/or the input voltage and the torque measured by a torque sensor. A closed-loop system of this kind would compensate for inaccuracies which arise owing to the operation of the electric drive at a sub-optimal operating point. As already mentioned, this can be attributed to material aging or increased temperature in the interior of the electric drive. This would not only result in the level of electrical assistance being accurately determined, but also in energy savings by means of changing the operating point of the electric drive.

The data obtained by the sensor, which are mainly used to determine the level of electrical assistance for a rider, can also be used for other purposes. For instance, it is advantageous for these data to be linked to the age and physical condition of the rider or to the average terrain over which the rider will travel. This would allow for a more customized selection of the electrical drive power and/or the battery capacity for a potential buyer on the basis of the riding experience of other riders. As a result, the price-performance ratio would be improved, since the potential buyer could select a bicycle having parameters which correspond to their performance level and/or the area in which they are riding, or the distances they want to cover on average. It is also conceivable to list these recommendations online where no qualified retailers are available, such that a potential buyer is warned that they are about to purchase an e-bike that potentially exceeds their capabilities. This would also increase the general safety both for the users of e-bikes and for all other road users.

The measurement of the torque can be used to monitor the state of the electric drive. By tracking the torque acting on the drive train, the drive can be monitored for signs of wear. This could contribute to preventing breakdowns and to extending the service life of the drive. Furthermore, the measurement of the torque can contribute to calculating different parameters of the electric motor such as speed, power, efficiency, and power factor. Using these parameters, the operating conditions of the motor can be monitored and optimized, which results in improved performance. It is also advantageous to use the torque measurement to optimize the bicycle algorithm.

It is also possible to install a sensor for determining the level of electric drive assistance in a pedal. A strain gauge could be used for this purpose, for example. In addition, it is also advantageous to use an accelerometer to measure the rotational speed of the pedal. The sensor can be calibrated in order to measure the intensity and frequency of the force that a rider is applying when pedaling. In order to ensure that the applied force is measured accurately, the sensor should be attached in the center of the pedal and securely connected to the pedal of the e-bike. The sensor should then be connected to the battery and the electric drive such that the level of electric drive assistance for a rider can be determined using the measurement from said sensor. Specifically, the analog signal from the strain gauge is converted into a readable digital signal by an amplifier. This signal can then be interpreted by means of a microprocessor, which is also programmed such that it determines the power that the electric drive should output at each point of the pedaling. It can be said that a force sensor integrated in a pedal constitutes a cost-effective solution which might be more precise in comparison with a torque sensor integrated in the drive housing, since it measures the force closer to its source, namely the pedal. It is worth mentioning that the sensor should be well sealed in order to prevent water from penetrating and dust from accumulating. Ultimately, the sensor should be connected or wired to the electric drive, the battery, and the controller.

The data measured by the sensor can be used to identify when a rider loses traction, in order to accordingly adapt the power so that the rider keeps the e-bike under control. By using sensors that measure the torque, the system can analyze the forces exerted by the rider on the pedals and ascertain when an increase in exertion by the rider could indicate that the tires are slipping or spinning. If it is ascertained that they are slipping, the system can respond by reducing the power output by the electric drive, thus allowing the rider to regain control. This system could be useful for novice riders who do not yet have experience in adapting the power output of their electric drive in order to keep control. By the system adapting the power output to changes in traction, it can help the rider to keep the e-bike under control even in difficult conditions.

The power of the electric drive should be dependent not only on the force with which the rider is pedaling, but also on the terrain which they are in. By adapting the power output of the electric motor to the terrain in question, the rider can better optimize the power of the e-bike. With a better understanding of the terrain and the correct torque measurements, the rider can enjoy a safer and more efficient ride. A drive system of the e-bike should take into account when the rider is riding on an unsurfaced track, on rough terrain, or on mud, since these are diametrically opposed conditions to a tarmac road for an e-bike. For this purpose, software can be used which identifies the optimal motor power on the basis of a selected multitude of different terrains. It is also advantageous for the rider to communicate their position so that the terrain in which they are riding can be identified. The drive system would then already activate the optimized mode suitable for the given terrain by means of the software.

One of the features of the e-bike that can result in inaccurate torque measurement is a poorly tensioned bicycle chain. For example, a poorly tensioned bicycle chain can cause uneven force transmission from a connecting link to a gear wheel. Furthermore, a bicycle chain of this kind increases the friction between the chain parts and results in excessive wear to the e-bike. If the bicycle chain is too loose, the chain can wear, which impairs the optimal performance. Conversely, if the bicycle chain is tensioned too much, this increases the risk that it will break. In addition, the bolts or screws are subjected to unnecessary load, which can likewise result in inaccurate measurements. In order to correctly tension the bicycle chain, the upper and lower chain on the chain ring and the cassette first have to be checked. The upper chain ring should be in parallel with the bicycle frame side, while the lower chain ring should be oriented with a slight upward slope toward the center of the chain ring. The correct tension of the chain can be automatically checked using a torque sensor and a strain gauge. If the rider presses down on the pedal with a certain force that is measured by the strain gauge, this force should be transmitted in a certain range, i.e. with a certain loss, to the axle of the wheel, which is then measured by the torque sensor. If these two measured values are within a preset range, the chain is correctly tensioned, otherwise the rider can be made aware that the chain needs to be correctly tensioned. This can also be done automatically using an automatic chain tensioner.

A torque sensor can be used to develop a braking assistance system. One possible solution is that the sensor sends information to a controller, which then determines, on the basis of this information, how much braking force should be applied. The controller could be configured such that it applies more braking force when a rider pedals harder, in order to provide more assistance. This would also contribute to making the braking more comfortable for the rider, since they do not need to exert so much force on the brakes to obtain the desired braking effect. Furthermore, this system could also be used for smoother braking, which could be helpful for riders who are not used to riding an e-bike. The torque sensor can also be used to develop a rider assistance system. Here, the sensor could be used to detect information regarding the torques of the bicycle. This information can then be relayed to a controller, which is capable of giving the rider specific instructions. For example, the controller could request that the rider apply more torque when this is required to reach a certain speed.

An optical sensor is an alternative to a sensor that measures the strength of the magnetic field and can be used for measuring the force with which a cyclist is pedaling. For this purpose, an optical sensor is attached around the bicycle axle. When an axle is subjected to a torque, this results in strain on the outer surface of the axle. The optical sensor can identify these surface movements, from which the torque can be calculated. Furthermore, a sensor of this kind can also be used to determine the cadence of a rider. For this purpose, an additional light source is required, which is directed toward a static point on the axle. The sensor can then count the occurrences of this point per time window and determine the cadence therefrom.

One of the aspects which negatively impacts not only the measurement of the torque but also the performance of the motor is it heating up in the drive housing. The heat generated by an electric motor can cause thermal expansion, which can lead to inaccurate torque measurements and a sub-optimal power output, since parts of the motor expand or contract at different rates. Furthermore, excessive heat can increase the friction between moving parts, which leads to inaccurate measured torque values and potentially damages the components. An increase in temperature in the electric drive also reduces its efficiency owing to greater electrical resistance, which leads to a lower power output. In addition, high temperatures can interfere with other electronic components that are used for measuring torque values and induce inaccurate measured values. In extreme cases, high temperatures in the housing can result in the motor overheating, which means that it becomes inoperative. For these reasons, it is important that the housing or the motor is cooled and the optimal temperature therein is ensured. This can be achieved by using various cooling systems. For instance, the installation of a fan in the housing can be taken into consideration, which has the advantage of having a low price. The drawback is, however, the low efficiency and also the power supply that is required. Another option is heat sinks, which can passively cool the electric drive. They do not require any power. On the downside, their efficiency is not great enough to cool high temperatures. Ultimately, a water cooling system also comes into consideration, which can cool the electric drive the best when compared with the other alternatives presented. This is, however, a complex device that has to be water-tight so as not to damage the components arranged in the housing.

An important point for a safe and comfortable ride is the proper functioning of all the components, in particular the electric drive, the battery, and the controller comprising a display. To ensure good and improved communication between the battery and the electric drive, it is important to update the software of the e-bike. In order to make riders aware of an available update, either a message could be sent from an e-bike application or it would also be possible to periodically trigger a message on an e-bike display that there is a possibility of a software update. Furthermore, data could be collected on how often the e-bike is ridden, such that personalized instructions can be given when the bicycle should undergo maintenance in order to check the state of the battery, the sensors, and the electric drive, for example. Lastly, during such maintenance, mechanical parts such as the circuit or the freewheel could also be replaced when the wear impairs the performance of the e-bike or the ride safety.

It is obvious to a person skilled in the art that all the embodiments described can be implemented in a claimed configuration of the present invention, provided that they are not explicitly mutually exclusive.

In the following, the present invention is then explained in greater detail on the basis of specific exemplary embodiments and drawings, without being limited to them.

By studying these embodiments and figures, further advantageous configurations of the present invention can become clear to a person skilled in the art.

### DESCRIPTION OF THE FIGURES

On the basis of the following figures, exemplary embodiments of the invention are described, with identical reference signs denoting identical or similar parts.

In the drawings:

FIG. 1 is a schematic perspective view of an e-bike;

FIG. 2 is a schematic perspective view of an electric drive;

FIG. 3 is an exploded view of an electric drive;

FIG. 4A is detailed exploded view of a first sensor;

FIG. 4B is detailed exploded view of a second sensor; and

FIG. 5 is a schematic graph of a torque signal measured inside and outside the housing.

### CARRYING OUT THE INVENTION

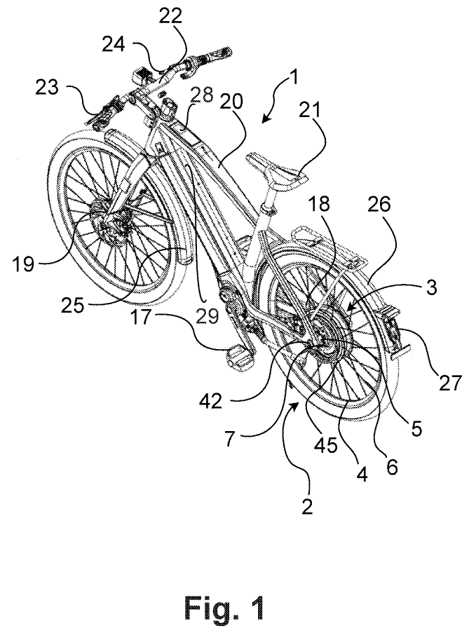

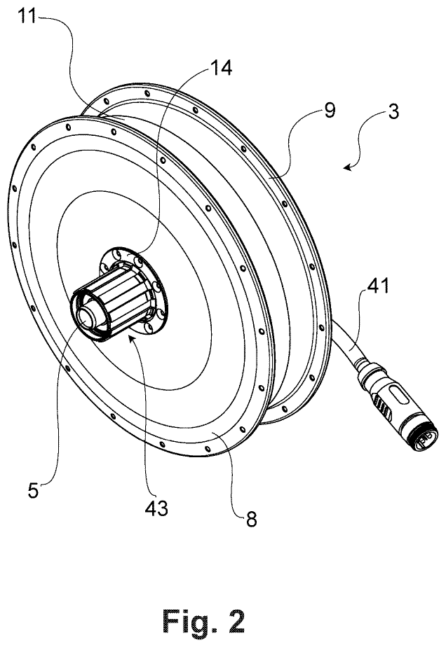

FIG. 1 is a schematic perspective view of an e-bike 1 and FIG. 2 is a schematic perspective view of an electric drive 3. An e-bike of this kind differs from a conventional bicycle in that it is equipped with an electric drive which assists the rider when they are pedaling, which saves their energy and generally increases the ride comfort. In addition, this concept is a more environmentally friendly and less noisy alternative to conventional mopeds or motorbikes. The e-bike comprises an electric drive 3 in or on the rear wheel and it is positioned around an axle 5 of the e-bike 1. The electric drive 3 is designed as external rotor and is connected to a wheel 2 of the e-bike 1 via spokes 6 and a rim 4. In the present case, it is advantageous for the spokes 6 to be connected to the electric drive 3 so as to be straight and thus not to require any bending.

Yet further components, such as a brake disk 7 or a belt pulley, are located on the electric drive 3, around the axle 5 of the wheel 2. The belt pulley consists of a certain number of teeth and is used to transmit the belt force to the freewheel 43. In addition, the belt pulley is positioned on a freewheel 43 and is coupled to pedals 17 by a belt 18.

Furthermore, the electric drive 3 is electrically connected to a battery 29 via a cable 41 (not shown here) and relevant information, such as speed or state of charge of the battery, is conveyed via a display 28. This display 28 can also be used to calibrate a sensor or torque sensor 12 or to lock the e-bike 1.

Other components of the e-bike 1 are a frame 20 in which the display 28 is integrated and which also contains the battery 29. In addition, the e-bike is equipped with handlebars 22, where the brake lever 23 and the gear lever 24 are fastened. In addition, a second display can be installed which displays information such as average speed and current speed, battery charge percentage, calorie consumption, and kilometers traveled. The e-bike 1 also has an adjustable saddle 21 and a front brake disk 19. Furthermore, the e-bike 1 is equipped with a front fender 25 and a rear fender 26, and with safety features such as a license plate mount comprising a reflector 27, or a bell.

FIG. 2 is a schematic perspective view of an electric drive 3. It is positioned around an axle 5 of an e-bike 1 and assists a rider when they are pedaling. More specifically, it is located in a rear wheel 2 and is connected to a rim 4 via spokes 6. A housing 11 of the electric drive 3 consists of two cover bodies 8, 9, which consist of metal or plastics material, for example. Furthermore, they together result in a closed component, which protects its interior against mechanical damage and other undesired external influences. As a result, the housing 11 is water-tight or splash-proof, which is essential for protecting the electric drive 3 for using the e-bike 1 when it is raining.

The housing 11 is screwed to the wheel 2 by a support element 14 and the axle 5 is connected to the wheel 2 by a quick-release axle 42. In addition, the housing 11 is connected to pedals 17 by a freewheel 43 and a belt 18. Lastly, the electric drive 3 is wired to a battery 29 of the e-bike 1 by a cable 41.

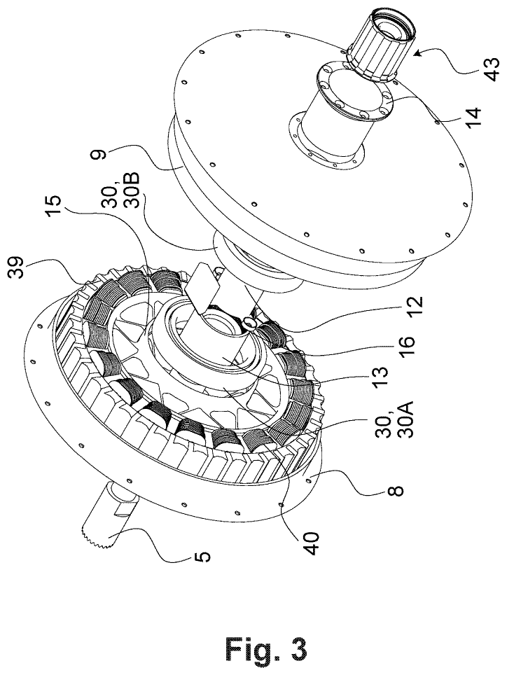

FIG. 3 is an exploded view of an electric drive 1. The electric drive 3 comprises a sensor 12 and a measurement element 13, which can be coupled to a freewheel 43. The sensor 12 acts to measure the drive assistance and is arranged in the region of an axle 5 of the wheel 2. Furthermore, the sensor 12 is designed as a torque sensor and it is rigidly connected to a carrier 15. The measurement element 13 is magnetized and the strength of the magnetic field is measured thereon by means of the sensor 12.

When the rider is pedaling, the magnetic field of the magnetized measurement element 13 changes, which can be made of ferromagnetic material, for example. This change measured by the sensor 12 can be referred to as the strength of the magnetic field.

This measurement is then evaluated to determine the level of electrical assistance for a rider, which is then also provided. It is advantageous that the harder the rider is pedaling, the greater the assistance provided, which gives a natural riding experience.

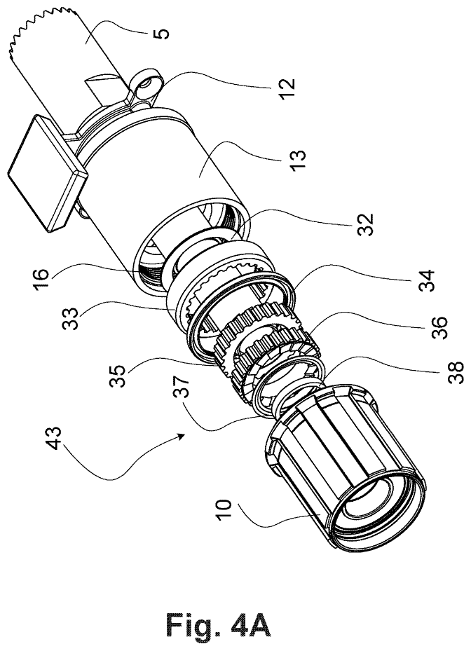

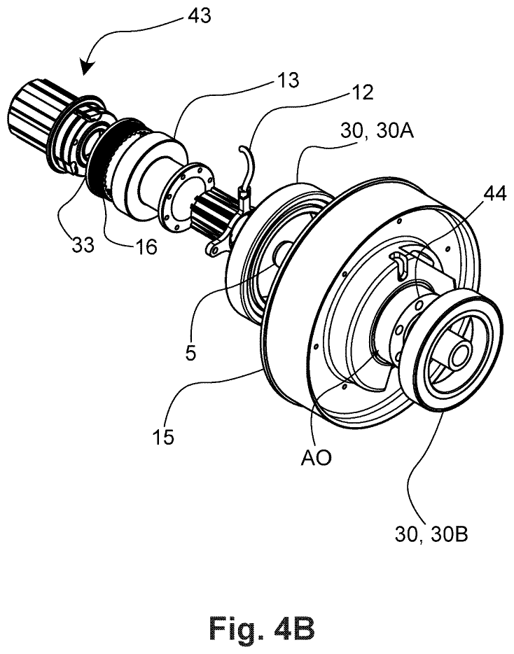

In addition, two bearings A and B, 30A and 30B here, are visible. FIG. 3 shows ball bearings, but other types of bearing, such as conical bearings or cylinder bearings, are also possible. The first bearing 30A is in contact with the carrier 15 via its outer ring. Furthermore, the second bearing 30B is coupled to the carrier 15 via its inner ring, i.e. it is fitted to an outer surface AO of a bearing seat 44 (cf. FIG. 4B).

Lastly, a rotor 39 and coils 40 are shown, which are basic components of the electric drive 3 together with the carrier 15 and serve to convert electrical energy into mechanical energy.

FIG. 4A shows a detailed exploded view with a sensor 12 and other components. A measurement element 13 is coupled to a freewheel 43 by means of a connection pattern 16, in this case a thread, and a connecting element 36. The magnetized measurement element 13 is also positioned on the sensor 12 in order for it to be possible to contactlessly measure the strength of the magnetic field thereon. All three components are arranged around an axle 5. The freewheel 43 contains various parts, such as two sprockets 35, 36, a spring 37, and a freewheel body 10. Lastly, a seal element 34, a spacer element 38, and a washer element 32 are shown, with the seal element 34 ensuring the sealing of the connection. The spacer element 38 together with the washer element 32 ensure the suitable axial positioning of the components.

FIG. 4B is a detailed exploded view with a second possible arrangement of a sensor 12 for measuring the torque in an electric drive. The sensor 12 is designed to detect the measurable force on a magnetized measurement element 13, which detects the pedaling force exerted by the rider. The measurement element 13 is strategically placed to make it possible to directly transmit the force that is conducted by a freewheel 43.

There is a carrier 15 comprising a bearing seat 44, which comprises an outer surface AO. A bearing 30, 30B is arranged on this surface A. The torque is measured by the sensor 12, which measures the measurable force on a magnetized measurement element 13.

The carrier 15 is likewise arranged around an axle 5 and comprises a second bearing 30, 30A. The measurable force is transmitted to the measurement element 13 by the free-wheel 43, which corresponds to a force with which a rider is pedaling.

Furthermore, the freewheel 43 is coupled to the measurement element 13 by a connecting element 33, and specifically by means of a connection pattern 16, which is a thread.

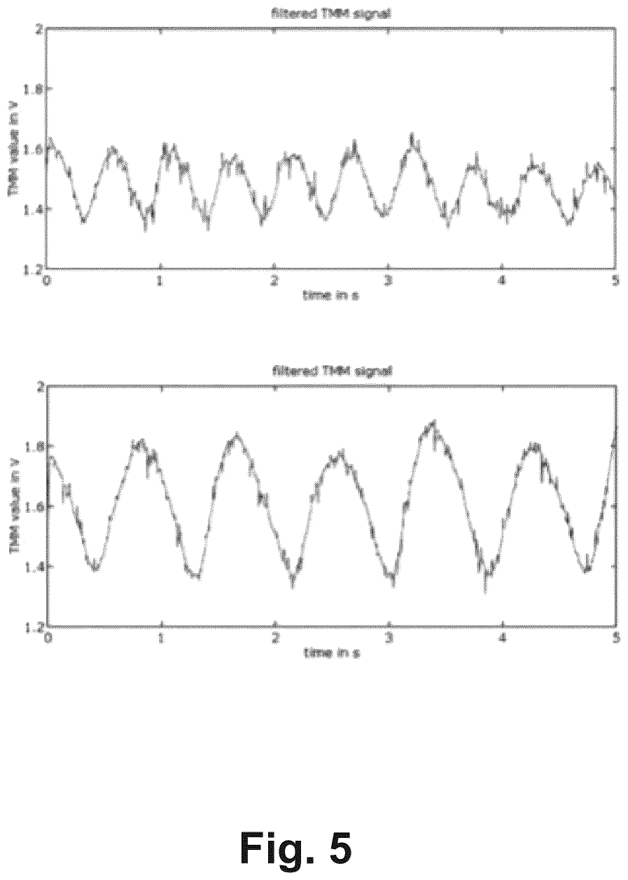

FIG. 5 is a schematic graph of a measured torque signal. The lower part of the graph shows the signal curve when the measurable force is measured outside the housing. By contrast, the upper part of the graph shows the signal curve that is measured when a sensor 12 is attached in a housing 11.

The sensor 12 is advantageously positioned in the interior of an electric drive 1 in order to protect it against adverse external influences such as weather or mechanical damage, and at the same time the signal measured in the interior is less dynamic and can therefore be evaluated more easily. A reliable and accurate measurement is the basis for correctly determining the level of electrical assistance that a rider requires when they are pedaling, meaning that a comfortable ride with a natural riding experience is ensured.

The present invention discloses an electric drive for an e-bike comprising an integrated sensor. It goes without saying that numerous other embodiments are conceivable for a person skilled in the art on the basis of the exemplary embodiments described by way of example.
1 E-bike/electric bicycle
2 Wheel
3 Electric drive
4 Rim
5 Axle
6 Spoke
7 Rear brake disk
8,9 Cover bodies
10 Freewheel body
11 Housing
12 Sensor
13 Measurement element
14 Support element
15 Carrier
16 Connection pattern
17 Pedals
18 Belt
19 Front brake disk
20 Frame
21 Saddle
22 Handlebars
23 Brake lever
24 Gear lever
25 Front fender
26 Rear fender
27 License plate mount comprising reflector
28 Display
29 Battery
30 Bearing
30A Bearing A or first bearing
30B Bearing B second bearing
32 Washer element
35,36 Sprocket
37 Spring
38 Spacer element
39 Rotor
40 Coil
41 Cable
42 Quick-release axle
43 Freewheel
44 Bearing seat
45 Spoke connection
AO Outer surface

1. An electric drive for an e-bike, comprising:
a housing, which comprises two cover bodies;
an axle guided through the two cover bodies;
a carrier comprising a bearing seat;
at least one bearing;
a sensor, which is arranged in the region of the axle of a wheel so as to measure the drive assistance; and
a measurement element, which is couplable to a freewheel by means of a connection pattern,
wherein a force being transmitted to the measurement element is detectable by the sensor, and
wherein the at least one bearing is attachable to an outer surface of the bearing seat.

2. The electric drive according to claim 1, wherein the sensor is positioned together with the measurement element in the housing of the electric drive.

3. The electric drive according to claim 1, wherein the measurement element has the shape of a sleeve in a manner integrated in the motor.

4. The electric drive according to claim 1, wherein the measurement element is magnetized.

5. The electric drive according to claim 1, wherein the two cover bodies are coupled to spokes of the wheel by a spoke connection.

6. The electric drive according to claim 1, wherein the housing is couplable to the wheel by a support element.

7. The electric drive according to claim 6, wherein the support element has a sleeve shape.

8. The electric drive according to claim 1, wherein the sensor is provided on the carrier.

9. The electric drive according to claim 1, wherein a force originating from pedaling is transmittable to the measurement element via the freewheel.

10. The electric drive according to claim 1, wherein a force being transmitted is measurable at the measurement element.

11. The electric drive according to claim 10, wherein the force being transmitted is detectable by the sensor in the form of a magnetic field strength.

12. The electric drive according to claim 1, wherein a measured force is transmittable to the electric drive and is usable to monitor a state of the electric drive.

13. The electric drive according to claim 1, wherein the sensor is designed as a force sensor and preferably as a torque sensor.

14. The electric drive according to claim 1, wherein the sensor is calibratable.

15. The electric drive according to claim 1, wherein the coupling between the freewheel and the measurement element takes place directly or exclusively in an intermediary manner.
